(19) United States
(12) Patent Application Publication
(10) Pub. No.: US 2002/0020791 A1
(43) Pub. Date: Feb. 21, 2002

(54) Bracket for attaching a hanging rod to a post at variable heights

(76) Inventors: Christopher Joseph Kempf, Columbus, OH (US); Pamela Ann Kempf, Carroll, OH (US)

Correspondence Address: Christopher J. Kempf, 7279 Woodale Drive North, Carroll, OH, 43112, US

(21) Appl. No.: 09/922,970

(22) Filed: Aug. 6, 2001

Related U.S. Application Data
(60) Provisional application No. 60/224,064, filed on Aug. 9, 2000.

(51) Int. Cl. A47B 96/06; A47G 29/00; A47K 1/00; E04G 3/00; F21V 21/00; F21V 35/00

(52) U.S. Cl. 248/218.4; 248/219.2

(57) ABSTRACT

A bracket tightened around a post which provides a channel through which the bottom portion of a rod with passes so that the rod is pinned within the bracket through a hole in the rod, thereby enabling items to be hung from a hook at the upper end of the rod.

### CROSS-REFERENCE TO RELATED APPLICATIONS This application claims the benefit of Provisional Patent Application No. 60/224,064, filed Aug. 9, 2000.

### STATEMENT REGARDING FEDERALLY SPONSORED RESEARCH OR DEVELOPMENT

Not applicable

### BACKGROUND of THE INVENTION

This invention relates to bracketed hangers, specifically a bracket that holds to a post a rod with a hook.

Posts are commonly used in home and business environments to hold such objects as mailboxes, plants, birdfeeders and signage. Posts also serve as patio deck, boat dock, and fence components. A typical post remains a single purpose function and is typically unadorned.

The space surrounding a post provides an opportunity to expand its utility. The air space surrounding a post is typically neglected as far as decorating or other display options are concerned.

Attaching a hanger to a post provides an option to fill airspace around a post with decorative or other objects. However, a typical post is away from power sources needed to drill screws into the post to hold hardware or fixtures to attach or hold objects. Also, the physical limitations or infirmity of the post owner may preclude heavy and even light invasive tool use. Also, nails and screws permanently violate or scar the integrity, surface or appearance of the post. Therefore, a bracket that compresses around a post would address these issues.

A further option is needed to easily raise or lower the height of the hanger without having to remove more permanent attachments. Being able to adjust the height of the hanger would facilitate growing plants, as well as a multitude of different sized objects to be changed throughout the year, such as seasonal or holiday decorations. A further option is need to easily remove a rod without tools. A bracket that permits a restraining or detent pin would address these issues.

These needs for increased functionality of post decorating with easy adjustability without the need for invasive and onerous tooling are solved by the invention.

Inventors have created brackets for mounting purposes. U.S. Pat. No. 4,455,007 to Varon and U.S. Pat. No. 4,316,547 to Varon are merely hanging rails with a bracket to provide support. They are neither adjustable nor applicable to a vertical post. The brackets are not affixed by compression. U.S. Pat. No. 5,337,954 to Kobilarcik and U.S. Pat. No. 3,861,635 to Juris disclose brackets for mounting a mailbox to a stanchion; however, the brackets are for a fixed placement for a limited purpose of attaching a mailbox to a post, and are not affixed by compression nor applicable for vertical or hanging usage. U.S. Pat. No. 5,738,319 to Grassi discloses an adjustable planter box hanger; however, the hanger requires two supports for affixing a box to a cross member, akin to a shelf structure, and is not effective for a vertical post. It provides an adjustment to accommodate the size of the box, and fails to provide for manual variable level adjustments, nor is it attached by compression.

Inventors have created hooks alone for plant pots. U.S. Pat. No. 4,908,982 to Quatrini discloses a bent rod with a hook on the other end that slips over a post that is anchored in a barrel. U.S. Pat. No. 5,586,413 to Sharon discloses just a pot hanger. However, neither includes a bracket mechanism. U.S. Pat. No. 4,908,982 is just the bent rod angled around the post with a bracket. The invention also lacks a bracket to hold the rod to the post to provide strength and stability. The invention also includes a barrel feature, whereby our invention is for a freestanding post.

U.S. Pat. No. 4,065,088 to Shell, and U.S. Pat. No. 4,205,815 to Sauer disclose an upright support brackets which are horizontal shelf supports that provide no hook mechanism for hanging, are not attached by compression and are inapplicable for hanging from a vertical post.

U.S. Pat. No. 5,203,817 to Klumpjan discloses a bracket that holds and supports a post at its base to provide stability to the post. It is provides no hook, no adjustability and is not attached by compression.

### BRIEF SUMMARY OF THE INVENTION

The preferred embodiment of the invention provides a bracket that wraps around or slips over a post. The bracket is held to the post by hand-tightening a nut onto a bolt. The tightening action draws a space of the bracket together, thereby compressing the bracket around the post. The bracket includes a slot for one end of a rod. The rod is held in place by a hand-inserted pin which goes through one of any selected holes of the rod, allowing the user to adjust the height of the rod as needed to accommodate the object being hanged. The other end of the rod extending from the post includes a hook for hanging an object. The rod can easily be raiser and lowered, or removed, by withdrawing the pin and to release the position of the rod. The bracket can easily be removed from the post by loosening the nut on the bolt of the bracket.

Accordingly, several objects and advantages of our invention are:

(a) to enable simple by-hand installation and repositioning of a bracket onto a post

(b) to provide an easy by-hand adjustment capability as to the level of a hanger from a post

(c) to allow the hanging of objects from a post without the need for invasive hardware such as screws or nails

(d) to provide hardware for hanging objects from a post and without the need for power tools

Further objects and advantages of our invention will become apparent from a consideration of the drawings and ensuing description.

### BRIEF DESCRIPTION OF THE SEVERAL VIEWS OF THE DRAWINGS

The above objects, features and advantages of this invention will be apparent in the following detailed description of the preferred embodiment, especially when taken in conjunction with the accompanying drawings, wherein

FIG. 1 is a lateral elevational view of the bracket before wrapped around a post;

FIG. 2 is a lateral view of the bracket showing how the bracket wraps around a post;

FIG. 3 is a top view of the bracket with a bolt through the tabs at each side of the opening coupled by a nut, and with a pin placed through the channel where the post is to be inserted;

FIG. 4 is a lateral view of the lower portion of the rod with holes;

FIG. 5 is a lateral view of the opening side of the bracket after the bolt is placed through the holes on the parallel tabs at each side of the opening and coupled by a nut, and showing the lower end of the rod lined up to be inserted into the channel;

FIG. 6 is a lateral view of the side of the bracket with the channel for the post, and showing the lower end of the rod inserted into the channel, and showing the pin inserted through one of the holes in the rod;

FIG. 7 is lateral view of the bracket showing how the bracket wraps around a post, and showing the lower end of the rod inserted into the channel with a pin inserted through the channel and one of the holes in the rod;

FIG. 8 is a lateral view of the invention in relation to the upper end of a typical mailbox post, showing the bracket wrapped around a post, such as a post for a mailbox as illustrated, with the lower portion of the rod pinned in the channel and with the upper hook end of the rod in a position to suspend a hanging object.

### DETAILED DESCRIPTION OF THE INVENTION

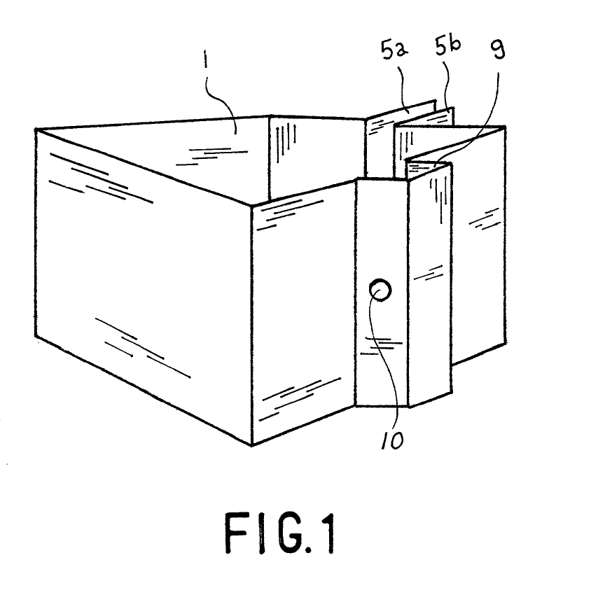

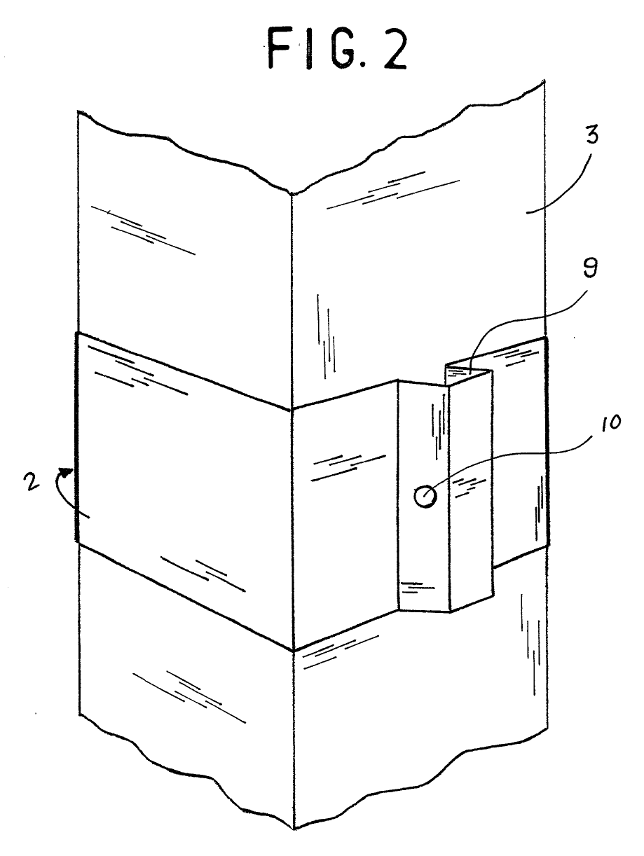

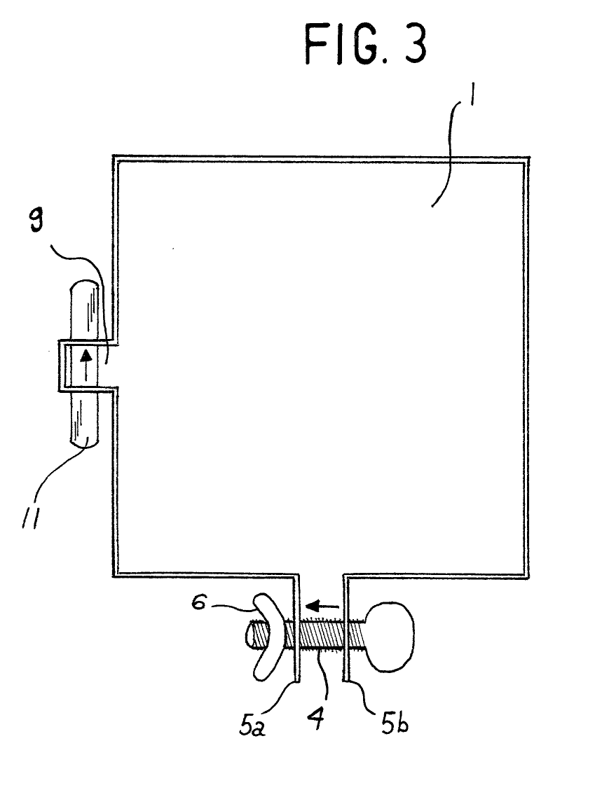

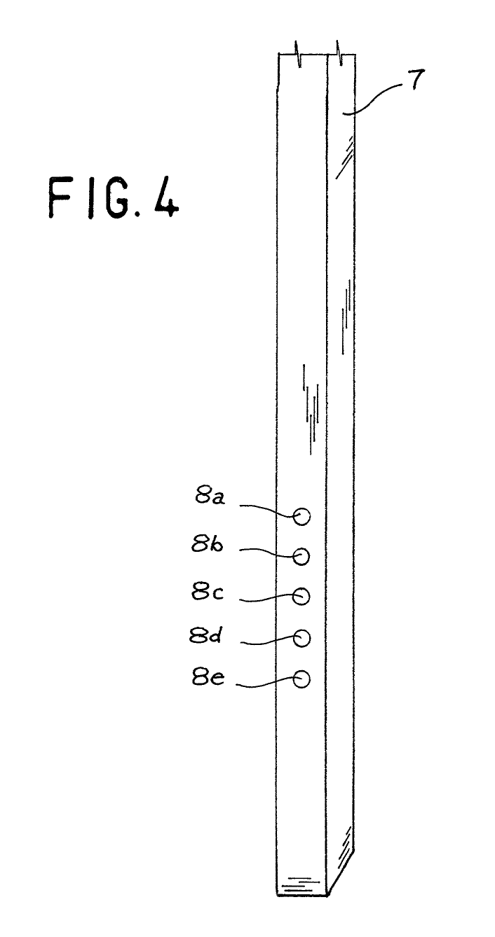

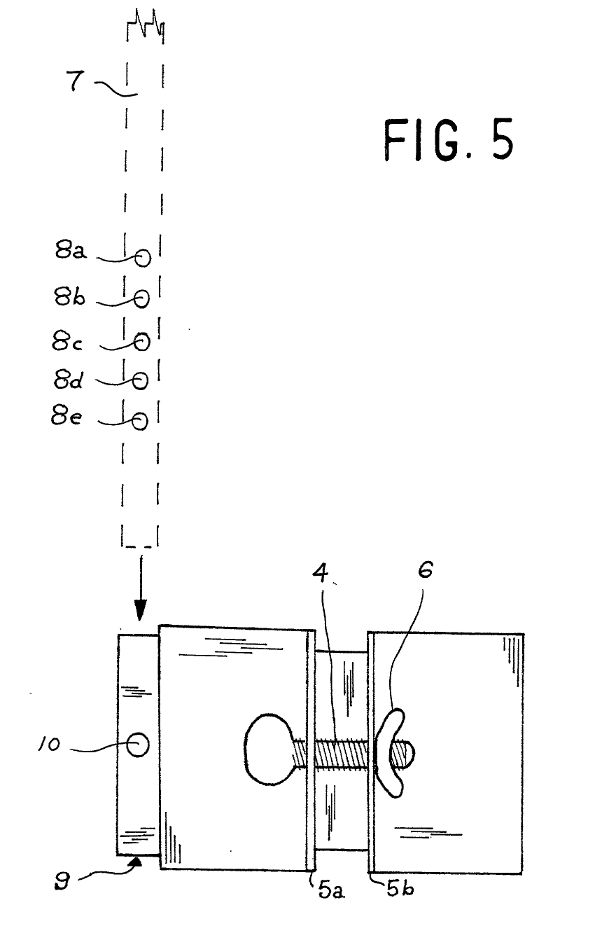

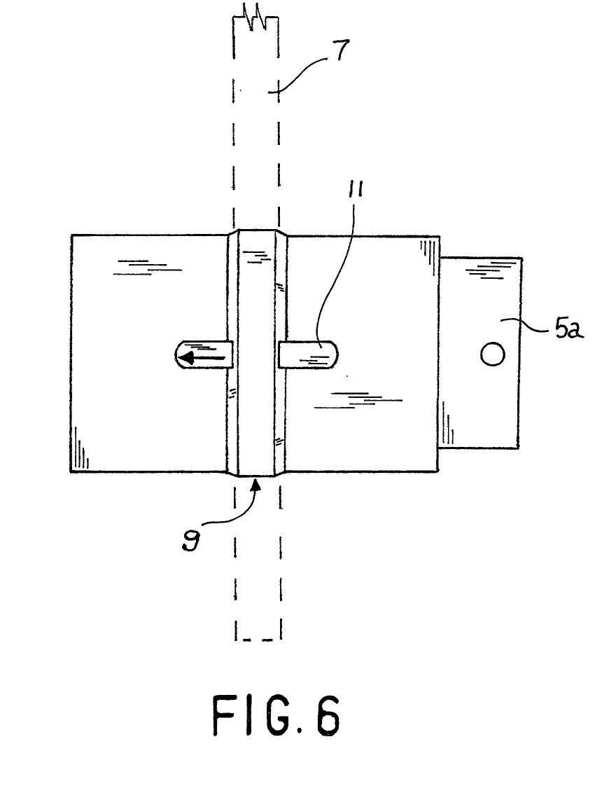

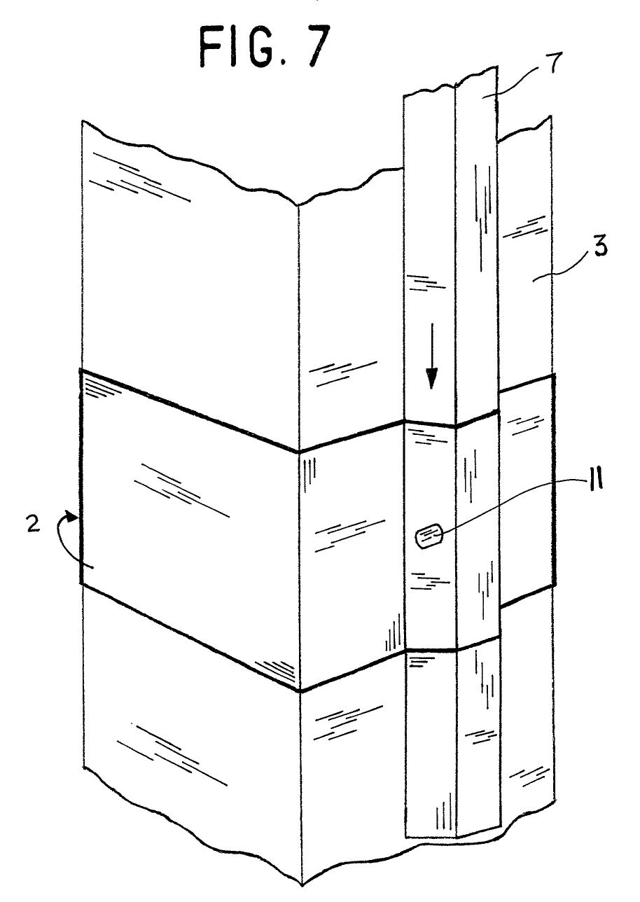

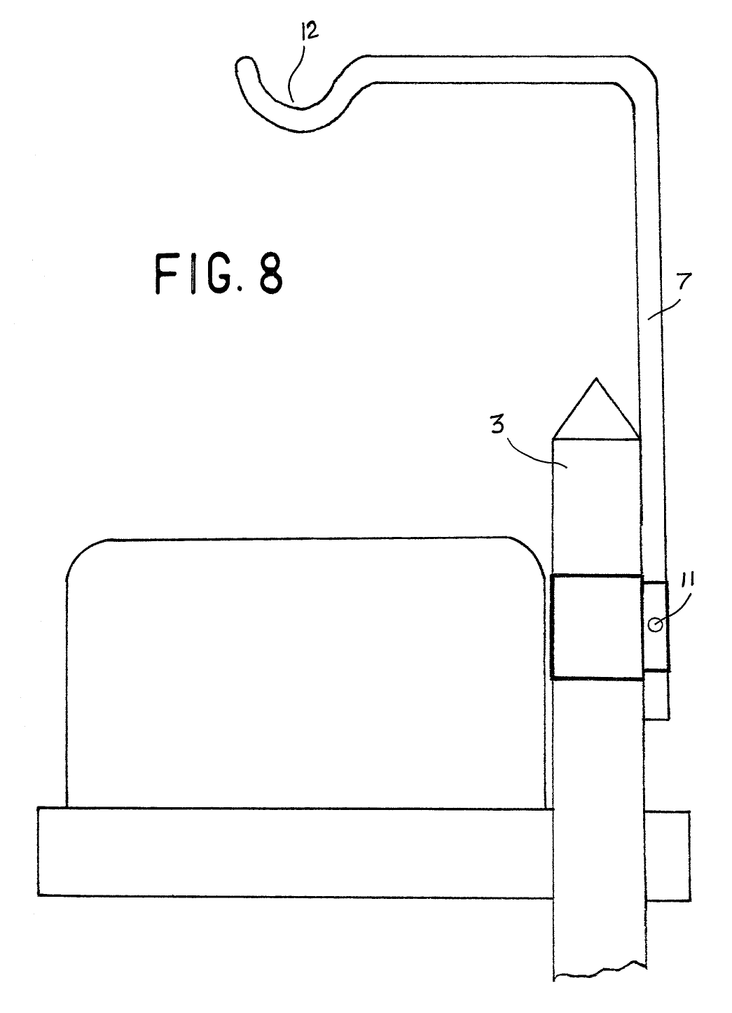

Referring now to the drawings in detail, the bracket (FIG. 1) provides enough space 1 to allow the bracket to wrap around 2 a post 3 (FIG. 2). After the bracket is positioned around the post a bolt 4 is inserted through the two holes of the parallel tabs 5a, 5b on each side of the opening of the bracket (FIG. 3). Tightened onto the bolt is a nut 6 to hold the bracket in a desired position on the post as a result of the compression of the bracket around the post, enabling the bracket to bear the weight of the rod and a fixture attached or displayed from the hook end of the rod without the bracket moving on the post once it is set in a desired position. The rod 7 with incrementally placed holes 8a-8e (FIG. 4) is inserted through the channel 9 on the bracket (FIG. 5), aligning one of the holes in the rod with the holes 10 of the channel so that a pin 11 may be inserted through the channel and rod (FIG. 6), completing the assembly (FIG. 7). Once the rod is pinned to the bracket, a wide range of decorating fixtures can be hung from the hook end 12 of the rod (FIG. 8).

The bracket is either slid over the top of the post and down into position on the post, or the bracket opens and wraps around the post. When the bracket is placed at the desired position on the post, a bolt is placed through the holes of the tabs projecting from the bracket at the opening, then a nut is tightened onto the bolt. The action of tightening the bolt then draws the space of the bracket together, compressing the entire bracket around the post.

Once the bracket is securely tightened, a rod is inserted into a channel of the bracket. The rod is held in place by a pin that goes through one of multiple holes bore through rod. The height of the rod can be changed by selecting another hole in the rod. The height of the rod can also be changed by loosening the nut of the bracket, then repositioning the bracket on the post, then again tightening the nut when the bracket is at the desired height.

Although a particular and preferred illustrative embodiment of the present invention has been described herein with reference to the accompanying drawings, the present invention is not limited to this particular embodiment. Various changes and modifications may be made thereto by those skilled in the art without departing from the spirit or scope of the invention. For example, the bracket of the invention can have another opening for another bolt and nut in order for the bracket to provide increased compression around the post, and to accommodate larger sized posts. The bracket does not have to be solid, but can be made of a rigid material displaying a cut design. Additional channels can be added for additional rods. The hook of the rod can be of a variety of shapes, such as a U-shape, V-shape, or even have a clasp to hold the hanging object. Also, instead of a pin going through the rod, a bolt or a screw can press again the rod to hold it in place.

The bracket component of the invention can be fabricated from a wide range of materials including metals and plastic.

Accordingly, the reader will see that the device can be used to easily attach a bracket and hanger to a post. It is an economical device that can be used by persons of almost any age without power equipment. Furthermore, the device has additional advantages in that

it allows for the level of the hook to be easily adjusted;

it enables easy installation of the bracket and rod;

it enables easy removal of the bracket and rod;

it enables a weight-bearing hook without need for screws or nails into the post;

it increase the functionally of posts;

it enables the easy beautification of a post environment.

We claim:

1. In combination, a bracket and rod device for hanging an object from a post, comprising a bracket around a post, and with said rod attached to the bracket by a pin.

2. The device of claim 1 wherein the bracket is held around the post by the compression from the coupling of an opening of said bracket by tightening a nut onto a bolt through said bracket and across said opening.

3. The device of claim 1 with said rod having a plurality of holes thereby permitting the pin to support the rod at heights determined by the hole selected.

4. The device of claim 1 with the distal end of said rod being in the shape of a hook to hold an object.

5. In combination, a bracket and rod device for hanging an object from a post, comprising a bracket held to a post by coupling a space of said bracket by a nut tightened onto a bolt across said space, and the bracket having a contiguous passage to allow a rod to pass through said passage, and with a hole on each side of the passage to enable a pin to penetrate and remain through the passage and through a hole of the rod with said pin restraining the rod at the level of the hole.

6. The device of claim 5 wherein said rod further includes a plurality of holes, thereby permitting the height of the rod to be restrained by the pin at a height depending on the level of the selected hole on the rod that the pin passes through.

7. The device of claim 5 with the distal end of said rod being in the shape of a hook to hold said object.

8. In combination, a bracket and rod for hanging an object from a post,
comprising in combination
a rod with a hole through the proximal end of the rod, and the distal portion of said rod providing a hook to support an object,
a bracket in the shape of the cross-section of said post allowing the bracket to fit around a post with the bracket having a separation between the ends of said bracket, and
from each end of the bracket adjacent to said separation there extends perpendicular from each bracket end parallel facing tabs with a hole in each said tab so as to permit a bolt to pass through each hole, thereby coupling the tabs after the bracket fits around the post and a nut is screwed onto the bolt, thereby providing compression of the bracket around the post, and
the bracket provides a space in the shape of the cross-section of the proximal end of said rod defining an aperture so as to allow said distal end of said rod to insert into and pass through said aperture, thereby positioning the rod along the post, and
the bracket provides a hole on each side of said aperture so as to allow the distal end of a pin to pass through the hole on one side of said aperture, then said distal end of said pin to pass through the hole of said rod, then said distal end of said pin to pass through the hole on the other side of said aperture, with the length of the pin remaining through and extending outside of the holes of said aperture, whereby the pin restrains the rod from passing further through the aperture and allowing the rod to be supported by the pin within the aperture.

9. The device of claim 8 with the rod having a plurality of holes at the proximal end of said rod, allowing said pin to penetrate any one of said holes, so as to enable the height of said rod to be determined by the selected hole of the rod being penetrated by the pin.

10. The device of claim 8 further including another separation of the bracket and adjacent to said other separation there extends perpendicular from the bracket another pair of parallel facing tabs with a hole in each tab permitting another bolt to pass through each hole, thereby coupling said other pair of parallel facing tabs after the bracket fits around the post and another nut is screwed onto said other bolt, thereby enabling the bracket to compress around a post at two separations as said nuts are tightened on each bolt at the two separations of the bracket, so as to provide increased compression of the bracket around the post
